(19) United States
(12) Patent Application Publication
(10) Pub. No.: US 2006/0120068 A1
(43) Pub. Date: Jun. 8, 2006

(54) Solar-powered bus stop

(76) Inventors: Damon H. Langlois, Victoria (CA); Christopher W. Paynter, Victoria (CA); James S. Ward, Saanichton (GB); Michael S. Marek, Victoria (CA)

Correspondence Address: CHRISTIE, PARKER & HALE, LLP, PO BOX 7068, PASADENA, CA, 91109-7068, US

(21) Appl. No.: 10/528,983

(22) PCT Filed: Sep. 24, 2003
(86) PCT No.: PCT/CA03/01457

§ 371 Date: Sep. 23, 2005

Related U.S. Application Data
(60) Provisional application No. 60/412,779, filed on Sep. 24, 2002.

(51) Int. Cl. F21L 4/00; F21V 21/00

(52) U.S. Cl. 362/157; 362/249

(57) ABSTRACT

A bus stop illuminating assembly used in public transportation system comprising a solar-powered head assembly for illuminating around said bus stop for security at night and signaling to a bus driver that passengers are waiting; an edge-lit bus schedule assembly to give transportation information to passengers; a post to secure said head assembly and said bus schedule assembly thereon, wherein necessary functions of said head assembly or said schedule assembly are selectively activated by said passengers, by means of a button assembly.

### CROSS REFERENCE TO RELATED APPLICATION

This application is a regular application based on U.S. Provisional Patent Application Ser. No. 60/412,779, filed Sep. 24, 2002, entitled “Solar-powered Bus Stop”, which is hereby incorporated herein by reference in its entirety for all purposes.

### FIELD OF THE INVENTION

The present invention relates to an improved bus stop for public transportation, more particularly to a solar-powered, illuminated bus stop.

### BACKGROUND OF THE INVENTION

A typical bus route consists of a series of bus stops. Typically these bus stops are no more than a post with a sign. While such a bus stop may be adequate during the day, at night it is not very effective. Firstly, such a bus stop can be difficult for a customer to locate in the dark. Secondly, in darkness it may be difficult for the bus driver to see if passengers are waiting, resulting in either unnecessary stops or drive-bys. Thirdly, such a bus stop does not provide any information regarding the bus schedule which is legible at night. Fourthly, a conventional bus stop does not provide any light so a customer can read while waiting for the bus, leaving customers standing in darkness where they may feel insecure.

Increasing urban congestion has led to major efforts to upgrade bus transportation systems in major urban centres, so that more drivers can be lured out of their cars and into the public transportation system. One important way of improving bus transportation is to increase the convenience and functionality of bus stops at night. The invention herein describes a new generation bus stop in which a variety of illumination functions are provided, with the power coming from a solar ‘power plant’ located on the top of the bus stop post.

The illumination functions include a light which automatically comes on at night to indicate the location of the bus stop, a control feature to allow this light to be increased in brightness for a set amount of time to serve as a convenience/security light, another light aimed at the bus driver and activated by the waiting customer to signal that the customer wants the bus to stop, and a light in a different assembly which illuminates the bus schedule on demand, so it can be read at night.

General practice, as well as the patent literature, does not teach us about the illumination of bus stops using solar power. However, other types of solar-powered lighting have been described. For example, the Applicant's previous U.S. patent, U.S. Pat. No. 6,013,985, describes a solar-powered, light-emitting diode (LED) hazard light in which a sealed, self-contained assembly contains all the necessary components for powering navigation or highway warning lights continuously for five years with no external source of power other than the sun. However, this is a signaling device which, like other related inventions, does not have a means for customer activation, nor the flexibility for illuminating signs and schedules, nor the ability to simultaneously address a variety of illumination functions: it is not suitable for the purpose of illuminating a bus stop.

With specific regard to using the solar-generated power from the head assembly to illuminate a sign or schedule, the patent literature does teach us about edge lighting. Edge lighting, which refers to illuminating a sign by shining light into the edge of the sign, rather than onto the front or through the back of the sign as is done conventionally, has been known for many decades. For example, U.S. Pat. No. 2,805,505 and U.S. Pat. No. 2,831,453 describe applications of edge lighting. However, these patents, and others which follow, teach about the use of ‘conventional’ incandescent light sources, typically using complex lensing systems and costly means of re-directing the light out to the viewer. The resulting complexity and cost have, in the past, made edge-lit signs un-competitive with conventional front-lit or back-lit signs.

LED light sources are better suited to edge lighting than conventional incandescent or fluorescent sources, because LEDs produce a focused light beam than can readily be trained into the edge of a sign without wasted light or the requirement for additional lensing. U.S. Pat. No. 6,076,294 teaches one means of using LEDs to provide edge lighting of a sign. The illuminated sign comprises a transparent plate and a series of light-emitting diodes. The transparent sign material is engraved from the back towards its front face so as to define a series of indicia. Each light-emitting diode is pressed into a recess opening at an outer periphery of the transparent plate, between the front and back faces. The recesses orient the light-emitting diodes so that a part of the boundary of each of the indicia is disposed within the viewing angle of at least one of the light-emitting diodes and so that another part thereof is not disposed within the viewing angle of any of the light-emitting diodes. An opaque material covers the back face of the photoconductive plate, at least where the back face is visible through the front face thereof, except where the photoconductive plate is inset so as to define the indicia. A fluorescent material covers the indicia and is adapted to fluoresce at a color matching the color of light emitted by the light-emitting diodes when energized.

U.S. Pat. No. 5,678,334 discloses a lighted display board such as an advertising sign, information sign, road sign, or the like, comprising a panel of transparent material which has at least one lighting element for illuminating the panel from the edge on at least one lateral defining edge. At least one of the two flat sides of the panel is at least partially covered with an opacifier film. The panel which is provided with the opacifier film is provided to backlight display symbols to be mounted onto the front flat side seen by an observer. The light reaching the contact face between the panel and opacifier film, form the panel into the opacifier film, is scattered by the opacification of the film, so that the entire opacifier film lights up and provides an evenly bright face for backlighting a panel provided with display symbols.

These patents show the state of the art in edge-lighting of signage. The first patent requires that schedule or sign information be engraved into the sign. This is expensive, and is clearly not suitable for bus schedules, which typically contain a lot of information and have to be changed from time to time. The second patent is more easily applicable to lighting schedules and signs at bus stops. However, it does not give even illumination of the sign surface: the edges adjacent to the LED light sources are much better lit than the centre of the sign or schedule.

The technology described herein advances edge lighting by describing a new technique that is very energy efficient, while providing very uniform lighting of the schedule surface. Furthermore, the technology is suitable for using in an assembly where the bus schedule can be printed on a translucent material and easily slipped into the bus schedule assembly.

Another aspect of illumination of a bus stop addressed in the present patent application is the provision of solar-powered signal light which can be activated by the customer to indicate to the bus driver that a customer is waiting. The concept of such a signal light is first described in U.S. Pat. No. 6,355,989, which discloses a ‘public transportation driver signaling device’ but does not teach how such a device would be sustainably powered.

### SUMMARY OF THE INVENTION

It is the purpose of this document to describe a solar technology that allows each bus stop to have electrical power independent of the electricity grid, and to use this power to meet the illumination requirements of transit users at the bus stop.

The head assembly of this invention is an independent power plant comprising a solar panel, a battery, and circuitry which are all combined into an integrated, self-contained unit that can be mounted on virtually any bus stop to provide electrical power to illuminate the bus stop.

It is a further object of this invention to provide a solar-powered head assembly containing a light source for illuminating the bus stop itself from dusk to dawn, and, upon activation by the transit customer, for increased illumination to improve night-time security and allow the customer to read while waiting for the bus.

It is a further object of this invention to provide a solar-powered head assembly that includes a light source which can be activated by the waiting transit customer to signal the bus driver that there is a customer waiting at the bus stop.

It is a further object of this invention to provide a solar-powered bus stop which comprises an edge-lit bus schedule assembly to give transportation information which can be read at night by passengers waiting at the bus stop.

It is a further object of this invention that the solar-powered head assembly provides power to LEDs in the buttons which are used to activate the lighting functions of the bus stop.

With particular regard to the bus schedule assembly, it is a further object of this invention to utilize LEDs to illuminate the edge of slightly diffusing acrylic, which in turn back-illuminates the bus schedule.

The preferred embodiment of the present invention provides a bus stop used in public transportation system comprising a solar-powered head assembly acting as a power plant and providing power to illuminate, on demand, LEDs within the head assembly that light the environs of the bus stop; and to illuminate, on demand, another LED in the head assembly which signals the bus driver, as well as to provide power to illuminate, on demand, a separate bus schedule assembly to give transportation information to passengers at night; and finally to illuminate LEDs located in control buttons located in or near the bus schedule assembly. Preferably, a post will be used to secure said head assembly and said bus schedule assembly thereon.

According to the present invention, the schedule assembly is illuminated with an edge-light function by LED. Further, the schedule comprises acrylic panel, reflective back material layer and a front cover layer. A translucent material layer on which the bus schedule is printed is slid behind the front cover. The schedule assembly further comprises a touch-sensitive capacitive button to activate illumination.

Accordingly, the present invention provides a bus stop illuminating device comprising:

a power storage device;

a solar panel to charge the power storage device;

at least one light source connected to the power storage device to provide illumination to the bus stop; and

at least one switch to control illumination of the at least one light source.

The present invention also provides alighting device for use at a bus stop comprising:

a solar panel;

a power storage device chargeable by the solar panel;

a first light source for illuminating an area adjacent the bus stop;

a second light source to signal a bus to stop;

a bus schedule assembly for displaying bus schedule information;

a third light source to illuminate the bus schedule assembly; and a switch assembly electrically connected between the power storage device and the light sources to allow operation of at least one of the light sources on actuation of the switch assembly.

In a further aspect, the present invention provides a bus stop illuminating device comprising:

a support structure;

a lighting assembly mounted to the support structure and housing

a power storage device;

a solar panel to charge the power storage device;

at least one light source connected to the power storage device to provide illumination to the bus stop; and

at least one switch mounted to the support structure to control illumination of the at least one light source.

These, together with other objects of the invention and with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 illustrates a schematic view of a bus stop with a solar-powered head assembly and a bus schedule assembly according to the present invention.

FIG. 2 illustrates a detailed view of the solar powered head assembly according to the present invention.

FIG. 3 illustrates an exploded view the solar-powered head assembly according to the present invention.

FIG. 4 illustrates an exploded view of the illuminated schedule assembly according to the present invention.

### DETAILED DESCRIPTION OF THE PREFERRED AND ALTERNATIVE EMBODIMENTS OF THE INVENTION

A solar-powered bus stop can be placed almost anywhere, without regard to the accessibility of grid electricity, and, with proper engineering, requires virtually no maintenance. The present invention utilizes a solar powered engine, light emitting diodes (LEDs), and edge lit signage to provide a multifunction, lighted bus stop.

The solar-powered head assembly of the present invention provides an autonomous power and light source in which a solar panel, a battery, circuitry and light sources are all combined into an integrated, self-contained unit that can be mounted on virtually any bus stop. The power from the head assembly can also be used to light a bus schedule assembly and control buttons located remotely from the head assembly, usually on the bus stop post below the head assembly.

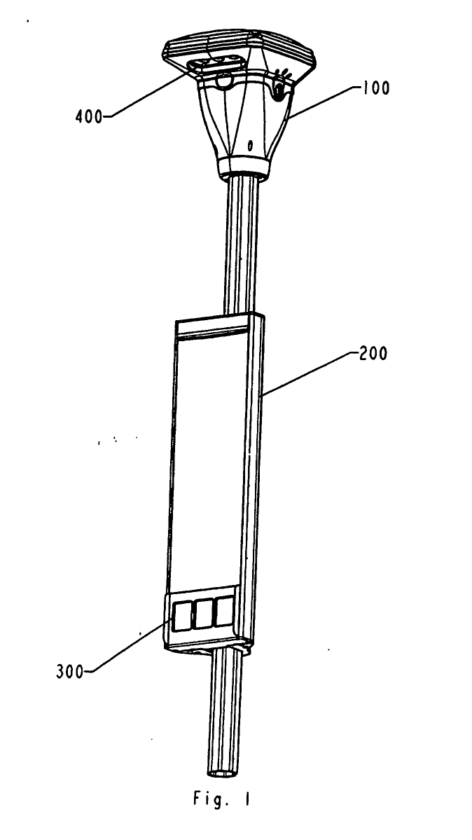

FIG. 1 illustrates a schematic view of a bus stop with a solar powered head assembly and a bus schedule assembly according to a preferred embodiment of the present invention. According to FIG. 1, the complete bus stop 400 according to the present invention comprises a solar powered head assembly 100. The lighted buttons 300 for controlling the illumination functions are arrayed at the bottom of the bus schedule assembly 200. The schedule lights up for nighttime viewing when the appropriate button is pressed. The button assembly 300 can also be used by the transit customer to activate illumination functions of the head assembly 200, including the bus signaling device and the security/convenience light.

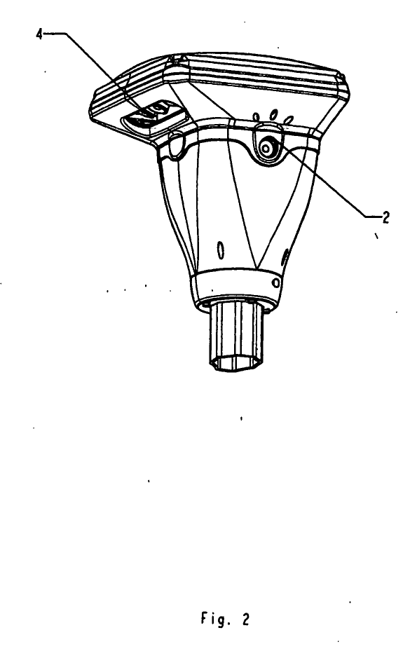

FIG. 2 illustrates a detailed view of a preferred embodiment of the solar-powered head assembly with the bus driver signal light and the security/convenience lighting according to the present invention. According to FIG. 2, the head assembly powers up LED lights 4 used for security and convenience lighting to provide enhanced security for waiting passengers. The head assembly also provides power to another LED light 2 used as a bus driver signal light 2 signaling that passengers are waiting.

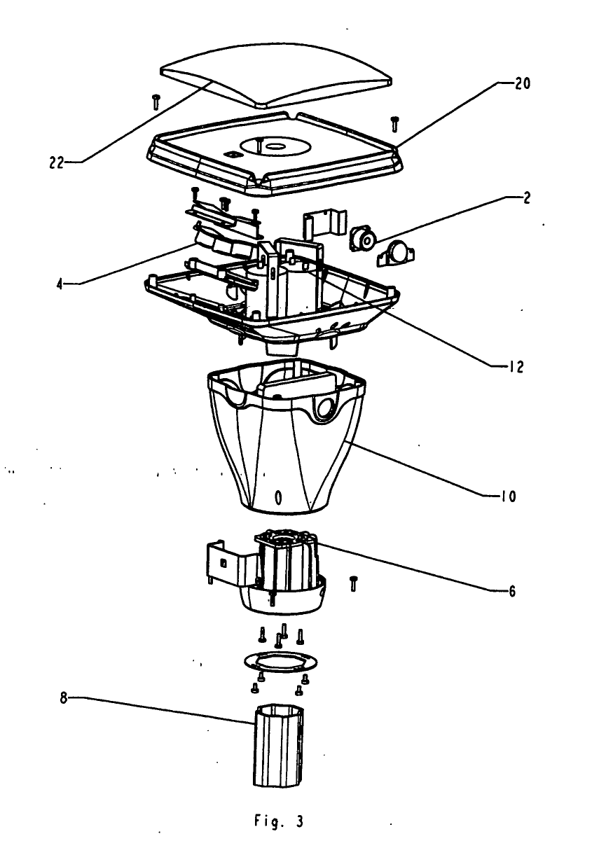

FIG. 3 shows an exploded view of the modular solar powered head assembly. According to FIG. 3, a universal mounting piece 6 is provided to mate with round, square, or octagonal post 8 with a predetermined thickness. That is, the solar powered head assembly according to the present invention may be applied to any of the previous, conventional bus stop posts. A housing 10 is the main portion of the head assembly which contains the battery assembly 12 and the LED light 2 for signaling the bus driver that a passenger is waiting at the bus stop.

The three LEDs 4 are used to provide security/convenience lighting to passengers. A top portion 20 of the head assembly according to the present invention is used to hold a domed solar panel 22. According to FIGS. 2 and 3 showing a preferred embodiment of the present invention, the modular solar powered head assembly is preferably a self contained, solar-powered modular power plant for the bus stop. It is designed to be compatible with all common bus stop posts.

In Applicant's co-pending PCT International application No. PCT/CA02/00574 filed Apr. 22, 2002, and entitled “Potted domed Solar Panel Capsule and Traffic Warning Lights Incorporating Same”, the disclosure of which is incorporated herein by reference, Applicant describes a polymeric doming process which protects the solar panel while allowing it to be placed horizontally and made integral to the light assembly without unduly compromising the performance of the solar panel relative to solar panel oriented more vertically in the traditional manner. Such a potted domed solar panel finds application in the apparatus of the present invention, however, other solar panel arrangements are also possible.

Preferably, the solar panel 22 is integrated to the head assembly and mounted horizontally so it is not visible from the street level, thereby avoiding the attention of the vandals who might be attracted by a solar panel protruding from the top of the bus stop. The solar panel 22 is incorporated into the head assembly preferably with the domed technique described in the above-referenced PCT International application. The solar panel is connected to the one or more batteries 12 that are also integral to the head assembly, so that the batteries charge when the head assembly is exposed to sunlight.

Further, the head assembly preferably contains circuitry which controls the various lighting functions, including preset shut-down of lights a set time after they have been activated by the transit customer. The circuitry may also adjust the power output of the head assembly using automatic control software, to ensure that the power supplied is adjusted depending on the availability of sunlight at the bus stop location. Commonly owned U.S. Pat. No. 6,573,659 issued on Jun. 3, 2003 and entitled “Solar-powered Light Assembly with automatic Light Control” describes automatic light control software which can be used in the control circuitry of the present invention. U.S. Pat. No. 6,573,659 is incorporated herein by reference. The software is designed to enhance the performance of solar-powered LED lighting by automatically regulating the power demand of the solar-powered device to conform to its solar environment.

The head assembly has an inventive modular design so that it can accommodate different LED light modules performing the following functions: lighting to indicate the location of the bus stop at night, security/convenience lighting for customers waiting for the bus, and a warning light to indicate to the bus driver that passengers are waiting.

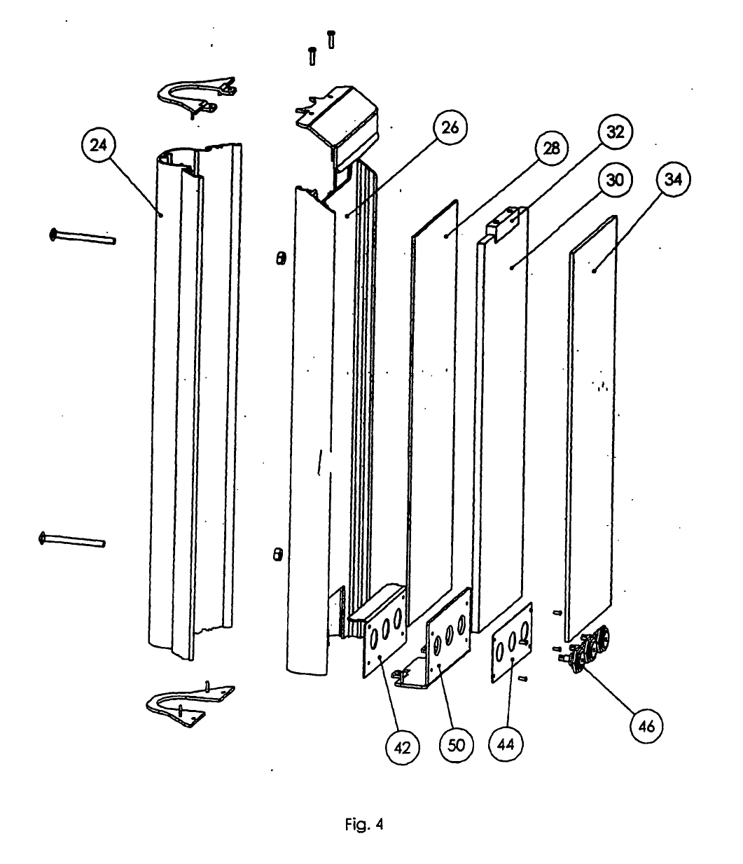

FIG. 4 illustrates an exploded view of the illuminated schedule assembly according to the present invention. A back piece 24 is used to secure the module to the bus stop post. A channel 26 is provided to hold three sheets: a reflective back material layer 28 which is placed at the back of the schedule, a transparent diffusing acrylic panel 30 which is edge-lit by the LEDs in a edge-light module 32, and a protective polycarbonate front cover layer 34 behind which the translucent material on which the bus schedule is printed is slid.

Further, a button assembly 300 is provided for controlling the illumination functions. At least one button is positioned at or near the bottom of the bus schedule assembly 200. as an ‘on’ switch for activating the schedule lighting on demand. The button is preferably lighted with a dim LED at night so it is easily located in the dark. Other buttons controlling the other lighting features in the head assembly may also be included in or near the bus schedule assembly. A three button assembly is illustrated in FIG. 4. These buttons 46 are mounted through a text/Braille plate 44 that identifies the function of each button. The buttons 46 are secured into a face plate 50 and a support bracket 42. After a light is activated by pressing the appropriate button, the light will turn off automatically after a preset amount of time to conserve power. However, the security light can be set to go dim rather than turn off, so that the bus stop is always gently illuminated at night to indicate its presence. The security light can then be increased in brightness for a preset time by pressing the appropriate button, after which the security light returns to its dim illumination mode.

The schedule assembly 200 described here uses an edge-lighting effect of a slightly diffusing acrylic panel 30 instead of a completely transparent panel. Due to the slightly diffusing nature of the acrylic panel 30, the light introduced into the edge of the panel emerges from the front and back faces of the acrylic panel 30 at very low angles. Light escaping from the back face of the acrylic panel 30 is reflected back into the acrylic by reflective back material 28 placed behind the acrylic panel 30. Light leaving the front face of the acrylic panel 30 enters a white translucent sheet material on which the bus schedule information is printed. The light passes through the translucent material, and is diffused widely so that it can be seen uniformly from all angles in front of the bus schedule. This method of illumination of a bus schedule is very energy efficient, while providing even illumination of the schedule.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order best to explain the principles of the invention and its practical application, thereby to enable others skilled in the art best to utilize the invention and various embodiments with various modifications as are suited to the particular use contemplated. It is intended that the scope of the invention be defined by the Claims appended hereto and their equivalents.

What is claimed is:

1. A bus stop illuminating device comprising:
a power storage device;
a solar panel to charge the power storage device;
at least one light source connected to the power storage device to provide illumination to the bus stop; and
at least one switch to control illumination of the at least one light source.

2. A device as claimed in claim 1 in which the at least one light source is a light emitting diode (LED).

3. A device as claimed in claim 1 including a second light source to signal a bus to stop and a second switch to control illumination of the second light source.

4. A device as claimed in claim 3 in which the second light source is a light emitting diode (LED).

5. A device as claimed in claim 1 including a display region for displaying information.

6. A device as claimed in claim 5 in which the display region includes a third light source to illuminate the display region and a third switch to control illumination of the display region.

7. A device as claimed in claim 6 in which the display region comprises a reflective back layer, a light diffusing intermediate layer adapted to be edge lit by the third light source, a translucent layer on which the information is displayed, and a protective front layer.

8. A device as claimed in claim 7 in which the third light source is a light emitting diode (LED).

9. A lighting device for use at a bus stop comprising:
a solar panel;
a power storage device chargeable by the solar panel;
a first light source for illuminating an area adjacent the bus stop;
a second light source to signal a bus to stop;
a bus schedule assembly for displaying bus schedule information;
a third light source to illuminate the bus schedule assembly; and
a switch assembly electrically connected between the power storage device and the light sources to allow operation of at least one of the light sources on actuation of the switch assembly.

10. The device as claimed in claim 9 including a head assembly for housing the solar panel, the power storage device, the first and second light sources and control circuitry for controlling charging of the power storage device by the solar panel, the head assembly being mountable to a post defining the bus stop.

11. The device as claimed in claim 10 in which the bus schedule assembly and the switch assembly are mounted in a housing mountable to the post.

12. The device as claimed in claim 9 in which the light sources comprise light emitting diodes (LED).

13. The device as claimed in claim 9 in which the third light source functions to illuminate the bus schedule assembly by edge lighting.

14. The device as claimed in claim 13 in which the third light source comprises a light emitting diode (LED).

15. The device as claimed in claim 9 in which the bus schedule assembly comprises a reflective back layer, a light diffusing intermediate layer adapted to be edge lit by the third light source, a translucent layer on which the bus schedule information is printed, and a protective front layer.

16. The device as claimed in claim 15 in which the light diffusing layer is formed from acrylic.

17. The device as claimed in claim 15 in which the protective front layer is formed from polycarbonate.

18. The device as claimed in claim 9 in which the switch assembly comprises a plurality of touch-sensitive capacitive buttons to activate the light sources.

19. A bus stop illuminating device comprising:
a support structure;
a lighting assembly mounted to the support structure and housing
a power storage device;
a solar panel to charge the power storage device;
at least one light source connected to the power storage device to provide illumination to the bus stop; and
at least one switch mounted to the support structure to control illumination of the at least one light source.

20. A device as claimed in claim 19 in which the support structure is a post.

21. A device as claimed in claim 19 including a second light source in the lighting assembly to signal a bus to stop and a second switch mounted to the support structure to control illumination of the second light source.

22. A device as claimed in claim 19 including a display region for displaying information mounted to the support structure.

23. A device as claimed in claim 22 in which the display region includes a third light source to illuminate the display region and a third switch to control illumination of the display region mounted to the support structure.

24. A device as claimed in claim 22 in which the display region comprises a reflective back layer, a light diffusing intermediate layer adapted to be edge lit by the third light source, a translucent layer on which the information is displayed, and a protective front layer.

25. A self-contained solar powered assembly for providing power under user control to a bus stop for the purpose of illumination of the bus stop.
